(19) United States
(12) Patent Application Publication
(10) Pub. No.: US 2010/0304960 A1
(43) Pub. Date: Dec. 2, 2010

(54) ALLOY FUEL CELL CATALYSTS

(76) Inventors: Tetsuo Kawamura, South-Glastonbury, CT (US); Lesia Protsailo, Bolton, CT (US); Marianne Pemberton, Manchester, CT (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/473,529

(22) Filed: May 28, 2009

(51) Int. Cl. H01M 4/88; H01M 4/92

(52) U.S. Cl. 502/101; 502/326; 502/325

(57) ABSTRACT

Alloy catalysts have the formula of PtXRh, wherein X represents one or two elements from the group consisting of Ti, Mn, Co, V, Cr, Ni, Cu, Zr, Zn, Fe, Ru, Pd, Re, Os, Ir, and Au. These catalysts can be used as electrocatalysts in fuel cells.

### FIELD OF THE INVENTION

This invention relates to alloy catalysts, especially rhodium-containing alloy catalysts, for use in fuel cells, as well as related methods of synthesis.

### BACKGROUND OF THE INVENTION

A fuel cell is an electrochemical device in which a fuel is oxidized to generate electricity. It comprises an anode, a cathode, and an electrolyte. The anode and cathode comprise catalysts that promote electrochemical reactions. In a polymer electrolyte membrane fuel cell (PEMFC) or a phosphoric acid fuel cells (PAFC), the fuel, often hydrogen, dissociates at the anode in the presence of the anode electrocatalyst to form protons and electrons. The protons migrate through the electrolyte and reach the cathode, where the cathode electrocatalyst facilitates the reaction between oxygen and protons to form water. The electrons, on the other hand, flow from the anode to the cathode through an external electrical circuit. This electrical current can be used to carry an electrical load. The electrolyte in a PEMFC is a polymeric membrane. In a PAFC, the electrolyte is concentrated phosphoric acid.

The electrocatalysts are highly active in facilitating their respective reactions but also have to endure the highly corrosive environment. Noble metal catalysts, e.g., platinum and it alloys, are the catalysts of choice. But platinum is very expensive. Researchers have been seeking ways to reduce the content of platinum or other expensive noble metals in electrocatalysts. One related approach to accomplish this result is to reduce the particle size of the metal catalyst so that, with the same amount of noble metal, the catalyst with smaller particle sizes has a larger electrochemical surface area (ECA). A larger ECA indicates that more active sites are present on the catalyst surface and accessible to the reactant molecules. Other conditions being the same, a catalyst with a larger ECA is more active than one with a smaller ECA.

Another related approach to reduce noble metal content in an electrocatalyst is to use substitutes for platinum or dopants so that the same level of catalytic activity is maintained using a smaller amount of noble metal. Both approaches are employed in developing active and stable electrocatalysts.

Electrocatalysts may deactivate over time. One of the mechanisms for catalyst deactivation is coalescing of small catalyst particles to form large particles (also known as sintering) over time on stream, causing loss of ECA and loss of catalytic activity. Reducing catalyst sintering can prevent or slow down this mode of catalyst deactivation.

### SUMMARY OF THE INVENTION

The present disclosure is generally directed to an alloy metal catalyst, which has high activity and stability. The catalyst comprises platinum, rhodium, and one or more other elements. Another aspect of the present disclosure is directed to a PAFC or a PEMFC that employs this catalyst as an electrocatalyst.

There is also disclosed a method of synthesizing an alloy metal catalyst comprising platinum and rhodium, as well as a method of using this alloy metal catalyst in a PAFC or a PEMFC.

Various embodiments of the present disclosure can be used in fuel cells and other similar or related applications. It is to be understood that the present invention is not limited by the embodiments described herein. Other features and advantages of the present invention will become more apparent from the following detailed description of the invention when taken alone or in conjunction with the accompanying exemplary drawing.

### DETAILED DESCRIPTION OF THE PREFERRED EMBODIMENTS OF THE INVENTION

The present disclosure is generally directed to catalysts comprising platinum and rhodium that can be used in a wide variety of applications. While the following discussion exemplifies fuel cell applications, especially in PEMFC or PAFC, the disclosure is not so limited. Rather, it is appreciated that the disclosure broadly encompasses any application that could utilize the alloy catalyst having a small amount of rhodium to prevent sintering of the catalyst particles. Therefore, while the invention described below is directed to a PEMFC or a PAFC electrocatalyst comprising platinum and rhodium, it is to be understood that the present invention is applicable to other types of fuel cells or catalytic reactions where this catalyst can be used.

It was found that the presence of rhodium in a platinum alloy metal catalyst deposited on a catalyst support has reduced the catalyst particle size. As broadly embodied herein, rhodium serves as the anchor for catalyst particles on the catalyst support. The catalyst particles therefore are less inclined to coalesce during the step of calcination in the electrode preparation process and in fuel cell operations. A “small amount,” as that term is used herein, means less than 10% molar percentage based on the total mole numbers of the metal elements in an alloy metal catalyst.

The catalyst of the present invention has the formula Pt—X—Rh, wherein X represents one or two elements selected from the group consisting of Ti, Mn, Co, V, Cr, Ni, Cu, Zr, Zn, Fe, Ru, Pd, Re, Os, Ir, and Au. Preferably X can be Ir and/or Co.

The molar percentage of platinum is preferable in the range of 40 mol % to 60 mol %. It is also preferable that the catalyst contains more than 1 mol % but less than 10 mol % of rhodium, for example, less than 5 mol % or less than 3 mol % in an alloy catalyst comprising platinum and one or more other elements. The resulting catalyst has a smaller average particle size than that without rhodium.

The catalyst can be deposited onto a catalyst support material, e.g., carbon black. The weight of the alloy catalyst is preferably in the range of 20 wt % to 60 wt % of the total weight of the catalyst and the catalyst support. The catalyst particle size is preferably between 30 Å to 90 Å.

The catalyst of the present invention may be made by any of a variety of methods. In one of the preferred methods, one or more water soluble compounds of the metal elements, i.e., platinum, rhodium, or X, are mixed with a carbon support in an aqueous solution. Then a reducing agent selected from the group consisting of hydrazine, sodium borohydride, formic acid, and formaldehyde is added to the aqueous solution. Subsequently, the metals precipitates in the form of metal salts or organometallic complexes and deposit on the carbon support. The liquid in the solution is then evaporated in a vacuum chamber to obtain a solid material, which contains metal catalyst precursors on the carbon support. If all metal precursors are not deposited in one step, the above process may be repeated until all metal precursors are deposited onto the carbon support.

The solid material obtained in the vacuum chamber is then calcined in an inert atmosphere at 600-1000° C. for 0.5-5 hrs before cooling down to room temperature. The resulting supported catalyst may be characterized to determine the composition of the catalyst, particle sizes, electrochemical surface area (ECA), etc.

Table 1 shows examples of catalysts obtained using a process described above. The catalyst in Example 1 is an alloy of platinum, cobalt, and rhodium on Ketjenblack® EC300 carbon black. Reference 1 is an alloy of platinum and cobalt on Ketjenblack® EC300. The particle size of both catalysts were measured based on X-ray Diffraction (XRD) data. The electrochemical surface areas of both samples were measured. The results shows that the PtCoRh catalyst has an average particle size of 31 Å and an ECA of 96.2 m²/g, while the PtCo catalyst has an average particle size of 51 Å and an ECA of only 25.7 m²/g.

The supported catalyst can be applied onto another substrate and used as a fuel cell electrodecatalyst. The PtXRh catalyst of the present invention may be particularly suitable for use as a cathode electrode catalyst in a PAFC fuel cell or a PEMFC fuel cell.

TABLE 1

| | | | | | | | | | | average | |
|---|---|---|---|---|---|---|---|---|---|---|---|
| | | wt % | | | | mol % | | | | particle | ECA |
| | sample | Pt | Co | Ir | Rh | Pt | Co | Ir | Rh | size (Å) | (m²/g) |
| Example 1 | PtCoRh | 38 | 8.8 | — | 3 | 52.2 | 40.0 | — | 7.8 | 32 | 96.2 |
| Example 2 | PtIrCoRh | | | | | | | | | | |
| Reference 1 | PtCo | 45.9 | 4.7 | — | — | 74.7 | 25.3 | — | — | 51 | 25.7 |
| Reference 2 | PtIrCo | 34.3 | 6.6 | 11.6 | — | 50.5 | 32.2 | 17.3 | — | 57 | 56.7 |

It will be apparent to those skilled in the art that various modifications and variations can be made without departing from the spirit of the invention. The present invention covers all such modifications and variations, provided they come within the scope of the claims and their equivalents.

1. An alloy catalyst having a formula of PtXRh,
wherein X represents one or two elements selected from the group consisting of Ti, Mn, Co, V, Cr, Ni, Cu, Zr, Zn, Fe, Ru, Pd, Re, Os, Ir, and Au,
wherein a molar percentage of the rhodium is between 1 mol % and 10 mol %.

2. (canceled)

3. The alloy catalyst of claim 1, wherein a molar percentage of the rhodium is between 1 mol % and 5 mol %.

4. The alloy catalyst of claim 1, wherein a molar percentage of the rhodium is between 1 mol % and 3 mol %.

5. The alloy catalyst of claim 1, wherein X is Ir and Co.

6. The alloy catalyst of claim 1, wherein X is Co.

7. The alloy catalyst of claim 1, wherein the alloy catalyst comprises particles provided on a catalyst support material.

8. The alloy catalyst of claim 7, wherein a size of the alloy catalyst particles is 30 Å to 90 Å.

9. The alloy catalyst of claim 7, wherein a weight percentage of the alloy catalyst based on a total weight of the alloy catalyst and the support material is 20 wt % to 60 wt %.

10. The alloy catalyst of claim 1, wherein the catalyst is a cathode electrocatalyst in a polymer electrolyte fuel cell or a phosphoric acid fuel cell.

11. A method of synthesizing an alloy catalyst having multiple metal elements, comprising:
mixing one or more of water soluble compounds of the multiple metal elements with a catalyst support material in water to form an aqueous mixture;
adding a reducing agent selected from the group consisting of hydrazine, sodium borohydride, formic acid, and formaldehyde to the aqueous mixture;
evaporating the liquid in the aqueous mixture to obtain a solid material; and
calcining the solid material in an inert atmosphere at 600-1000° C. for 0.5-5 hrs.

12. The method of claim 11, wherein the multiple metal elements comprising platinum, rhodium and at least one element selected from the group consisting of Ti, Mn, Co, V, Cr, Ni, Cu, Zr, Zn, Fe, Ru, Pd, Re, Os, Ir, and Au.

13. The method of claim 11, wherein a molar percentage of rhodium based on the total amount of metal in the alloy catalyst is between 1 mol % and 10%.

14. A polymer electrolyte fuel cell, comprising:
a cathode electrocatalyst having a formula of PtXRh,
wherein X represents one or two elements selected from the group consisting of Ti, Mn, Co, V, Cr, Ni, Cu, Zr, Zn, Fe, Ru, Pd, Re, Os, Ir, and Au, and
wherein a molar percentage of the rhodium is between 1 mol % and 10 mol %.

15. A phosphoric acid fuel cell, comprising:
a cathode electrocatalyst having a formula of PtXRh,
wherein X represents one or two elements selected from the group consisting of Ti, Mn, Co, V, Cr, Ni, Cu, Zr, Zn, Fe, Ru, Pd, Re, Os, Ir, and Au, and
wherein a molar percentage of the rhodium is between 1 mol % and 10 mol %.
